(19) United States
(12) Patent Application Publication
(10) Pub. No.: US 2017/0174976 A1
(43) Pub. Date: Jun. 22, 2017

(54) COMPOSITIONS AND METHODS FOR TREATING A SUBTERRANEAN FORMATION

(71) Applicant: Schlumberger Technology Corporation, Sugar Land, TX (US)

(72) Inventors: Hemant Kumar Jethalal Ladva, Missouri City, TX (US); Shitong S. Zhu, Waban, MA (US); Bruno Lecerf, Houston, TX (US); Zinaida Usova, Tomsk (RU); Mei Ki Ho, Houston, TX (US)

(21) Appl. No.: 14/976,961

(22) Filed: Dec. 21, 2015

(51) Int. Cl. C09K 8/42; E21B 33/138; C09K 8/44

(52) U.S. Cl. CPC C09K 8/426; C09K 8/44; E21B 33/138

(57) ABSTRACT

A degradable composite composition including polyglycolic acid and a boron-containing accelerator, and methods of using the same (for example, as a constituent of a treatment fluid of a subterranean formation) are described. The degradable composite composition may be a composition that degrades in environments typically encountered downhole, such as oilfield environments/conditions and/or fluids.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a treatment fluid to interact with a subterranean formation in a manner that ultimately increases oil or gas flow from the formation to the wellbore for removal to the surface.

In numerous downhole operations and environments, it would be advantageous to be able to utilize a component comprised of a degradable polyglycolic acid (PGA) composition in which the interaction with its fluidic environment and/or the decomposition of the degradable composition could be manipulated in a controlled manner. The degradation of PGA on its own in aqueous environment is relatively slow (on the order of weeks) particularly at a low temperature range (such as a temperature range of from about 90° F. to about 160° F.). Such slow degradation kinetics in diverting application in low temperature wells and particularly for multistage fracturing applications is not conducive. Such degradation kinetics may also not be appropriate in applications where PGA compounded material is used as one of the components in a down hole tool Therefore an accelerator is required to degrade PGA.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, the present disclosure relates to methods for treating a subterranean formation, the methods including injecting, into a downhole environment, a fluid including a degradable composite material comprising polyglycolic acid and a boron-containing accelerator, forming a plug at a first location in the subterranean formation, diverting the fluid to a second location in the subterranean formation, and removing the plug formed in the first location in the subterranean formation.

### BRIEF DESCRIPTION OF THE DRAWINGS

The manner in which the objectives of the present disclosure and other desirable characteristics may be obtained is explained in the following description and attached drawings in which:

FIG. 1 shows a graphical representation of a plot of the degradation of a composite extruded pellet (including PGA compounded with 7% (by weight) anhydrous borax) over time at 150° F., 130° F. and 100° F. in deionized water;

FIG. 2 shows a graphical representation of a plot of the degradation of a composite extruded pellet (including PGA compounded with 30% (by weight) anhydrous borax) over time at 150° F., 130° F. and 100° F. in deionized water;

FIG. 3 shows a graphical representation of a plot of the degradation of a composite extruded pellet (including PGA; anhydrous borax omitted) over time at 150° F., 130° F. and 100° F. in deionized water;

FIG. 4 shows a graphical representation of a plot of the degradation of a composite extruded pellet (including PGA compounded with 1%, 3%, or 5% (by weight) anhydrous borax) over time at 150° F. in deionized water; and

FIG. 5 shows a graphical representation of a plot of the degradation of a composite extruded pellet (including PGA compounded with either 20% or 30% (by weight) anhydrous borax) over time at 100° F. in deionized water.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The present disclosure relates to a degradable composite material (having a predetermined solubility/degradation kinetics) comprising polyglycolic acid (PGA) and a boron-containing material, such as borax (Na₂B₄O₇), which degrades and/or dissolves downhole, and methods of using the same (for example, as a constituent of a treatment fluid of a subterranean formation) are described. In some embodiments, the degradable composite material may be tailored to achieve accelerated degradation at Ultra Low Temperatures (such as temperatures lower than about 65° C., or at temperatures lower than about 60° C., or at temperatures lower than about 50° C., or at an average temperature in the range of from about 30° C. to about 65° C.).

As used herein, the phrase “degradable composite material” refers to a tangible element created by arranging several components, or sub-compositions, to form a unified whole that includes combinations of materials that may be used to achieve the purposes of the present disclosure. In some embodiments, the degradable composite material may be a composition PGA and a boron-containing material, where the composition is manufactured in a desired form or shape. Such compositions may be applied in a multitude of oilfield operations. The components (and proportions thereof) of the composition of the present disclosure may be adjusted to enhance or delay the interaction or rate of degradation of the composition with its environment, such as, for example, an aqueous environment that is dissolves the degradable composite material.

As used herein, the terms “degrading”, “degradable”, or “degrade” mean any instance in which the integrity of the composition is compromised (for example, due to the composition dissolving (partial or complete dissolution), and/or breaking apart into multiple pieces, and/or eroding by physical abrasion, chemical reactions, or a combination of physical abrasion and chemical reactions).

As used herein, the term “treatment fluid,” refers to any pumpable and/or flowable fluid used in a subterranean operation in conjunction with a desired function and/or for desired purpose. Such treatment fluids may be modified to contain a degradable composite material. In some embodiments, the pumpable and/or flowable treatment fluid may have any suitable viscosity, such as a viscosity of from about 1 cP to about 10,000 cP (such as from about 10 cP to about 1000 cP, or from about 10 cP to about 100 cP) at the treating temperature, which may range from a surface temperature to a bottom-hole static (reservoir) temperature, such as from about 0° C. to about 150° C., or from about 10° C. to about 60° C., or from about 25° C. to about 55° C., and a shear rate (for the definition of shear rate reference is made to, for example, Introduction to Rheology, Barnes, H.; Hutton, J. F; Walters, K. Elsevier, 1989, the disclosure of which is herein incorporated by reference in its entirety) in a range of from about 1 s⁻¹ to about 100,000 s⁻¹, such as a shear rate in a range of from about 100 s⁻¹ to about 10,000 s⁻¹, or a shear rate in a range of from about 500 s⁻¹ to about 5,000 s⁻¹ as measured by common methods, such as those described in textbooks on rheology, including, for example, Rheology: Principles, Measurements and Applications, Macosko, C. W., VCH Publishers, Inc. 1994, the disclosure of which is herein incorporated by reference in its entirety. As used herein, the term “treating temperature,” refers to the temperature of the treatment fluid that is observed while the treatment fluid is performing its desired function and/or desired purpose, such as fracturing a subterranean formation.

The term “fracturing” refers to the process and methods of breaking down a geological formation and creating a fracture, such as the rock formation around a wellbore, by pumping a treatment fluid at very high pressures (pressure above the determined closure pressure of the formation), in order to increase production rates from or injection rates into a hydrocarbon reservoir. The fracturing methods of the present disclosure may include a degradable composite material (having a predetermined solubility/degradation kinetics) comprising polyglycolic acid (PGA) and a boron-containing material, such as borax (Na₂B₄O₇) in one or more of the treatment fluids, but otherwise use conventional techniques known in the art.

The term “treatment,” or “treating,” does not imply any particular action by the fluid. For example, a treatment fluid placed or introduced into a subterranean formation subsequent to a leading-edge fluid may be a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a driller fluid, a frac-packing fluid, or gravel packing fluid. In the methods of the present disclosure, any one of the above fluids may be modified to include one or more degradable composite materials of the present disclosure. The treatment fluids comprising degradable composite materials of the present disclosure, may be used in full-scale operations, pills, slugs, or any combination thereof. As used herein, a “pill” or “slug” is a type of relatively small volume of specially prepared treatment fluid placed or circulated in the wellbore. For example, in some embodiments, the degradable composite materials (comprising PGA and an anhydrous boron-containing material) may be in the shape/form of fibers, rods, flakes, films, and/or particles and used, such as, for example, to stabilize proppant pack, improve facture geometry, produce fluid diversion, improve sand management, and mitigate lost circulation, in drilling, cementing and completion operations.

The degradable composite materials of the present disclosure may comprise PGA polymer(s) (and/or oligomers thereof) and a boron-containing accelerator (such as an anhydrous boron-containing accelerator, which may be in a particulate form) that degrades in water, such as at low temperatures, such as temperatures below about 65° C., or temperatures below 60° C., such as at an average temperature in the range of from about 30° C. to about 60° C., or at an average temperature in the range of from about 40° C. to about 55° C. In some embodiments, the degradable composition may comprise degradable polymers, in addition to PGA, as a component of the polymer matrix and one or more different particulate forms or sizes (or a distribution of sizes) of the boron-containing accelerator in the polymer matrix (the polymer matrix comprising PGA).

The boron-containing accelerator may be any solid boron-containing material that chemically reacts with water (under predetermined conditions, such as the heat of a subterranean environment) to form one or more reaction products where the reaction products are more soluble than the boron-containing accelerator. In some embodiments, the solid boron-containing accelerator may be anhydrous or of a partial hydration state capable of chemically reacting with water to form one or more reaction products where the reaction products are more soluble than the boron-containing accelerator. Examples of the boron-containing accelerator that may be used include, for example, anhydrous sodium tetraborate, sodium tetraborate monohydrate, and anhydrous boric acid.

In some embodiments, the total time required for the boron-containing accelerator, such as anhydrous borate materials, to degrade upon contact with an aqueous fluid may be in the range of from about 2 hours to about 7 days, such as in the range of from about 6 hours to about 3 days, or in the range of from about 12 hours to about 2 days, depending upon the temperature of the treatment zone in which they are placed. With time and heat, such as the heat of the subterranean zone, the boron-containing accelerator reacts with the surrounding aqueous fluid and is hydrated. The resulting hydrated reaction products are highly soluble in aqueous as compared to the boron-containing accelerator and as a result can be dissolved in the aqueous fluid, which then allows exposes a higher degree of surface area for the resulting aqueous fluid to contact and act upon the PGA polymer matrix.

In some embodiments, the methods of the present disclosure may employ degradable composite compositions in which particulates of boron containing accelerator particulate distributed (either homogeneously or heterogeneously) in a polymer matrix comprising PGA. The particle sizes of the boron-containing accelerator particulate may be in any desired range, such as in the range of from about 100 nm to about 500 microns, or in the range of from about 1 micron to about 200 microns, or in the range of from about 5 microns to about 150 microns. In some embodiments, smaller boron containing accelerator particulates (such as a plurality of particulates having an average diameter in the range of from about 30 microns to about 200 microns, or in the range of from about 50 microns to about 100 microns) with larger total surface area can be used to achieve faster degradation at the given temperatures compared to larger boron containing accelerator particulates (such as a plurality of particulates having an average diameter in the range of from about 500 microns to about 1000 microns) with smaller total surface area.

The terms “size” and “particle size” as used in the present disclosure (when referring, for example, to a sphere, bead, pellet, flake, and irregular shaped particle) refer to the diameter of the smallest imaginary circumscribed sphere that includes the shape. In some embodiments, the average size of the boron-containing accelerator (such as an anhydrous boron-containing accelerator) may be in a range of from about 1 μm to about 500 μm, or an average size in a range of from about 10 μm to about 200 μm, or an average size in a range of from about 20 μm to about 150 μm.

The loading of the boron containing accelerator (such as in a particulate form) as a weight percentage of the total composite may be in the range of from about 0.5% to about 40%, such as in the range of from about 2.0% to about 30%, or in the range of from about 5% to about 20%. In some embodiments, the loading of the boron containing accelerator (such as in a particulate form) may be selected depending on the desired decomposition characteristics of the final composite material.

In some embodiments, the degradable compositions comprising particulate-filled composites may be prepared to achieve an accelerated degradation, measured as weight loss % of the original weight, compared with the correspondent matrix polymer comprising PGA at a respective temperature, such as at 65° C. or at 60° C. (or at a temperature below about 60° C., such as an average temperature in the range of from about 30° C. to about 60° C., or an average temperature in the range of from about 40° C. to about 55° C.) in water in a predetermined time period, such as less than 30 days, or less than 2 weeks, or less than one week. In some embodiments, the degradable composite materials of the present disclosure achieve more than about 60% degradation (weight loss %), such as more than 80% degradation (weight loss %), or more than 90% degradation (weight loss %), or 100% degradation (weight loss %) within 7 days at low temperatures, such as temperatures below about 65° C., or temperatures below about 60° C., such as an average temperature in the range of from about 30° C. to about 60° C., or an average temperature in the range of from about 40° C. to about 55° C.

The phrase “degradable PGA polymers” herein refers to PGA polymers that are capable of being degraded (for example, breaking down into oligomers and/or monomers) in the presence of water or an aqueous environment. PGA polymer degradation in water is measurable by the weight loss of the solid PGA polymers over a period of time. A decrease of molecular weight of the PGA polymer (measured by Gel Permeation Chromatography, intrinsic viscosity or other known methods to characterize molecular weight of the polymers) can also be used to measure degradation.

Examples of the suitable degradable PGA polymers for preparing the degradable composites of the present disclosure include, for example, poly(glycolic acid) (PGA), and copolymers including glycolic acid monomer units, such as, for example, poly(lactic-co-glycolic acid), along with other glycolic acid containing copolymers, blends, derivatives or combination of any of these degradable polymers. The degradable PGA polymers may have an weight average molecular weight (Mw, as determined by, for example, GPC) in the range of from about 50,000 to 20,000,000, such as in the range of from about 100,000 to about 3,000,000.

The poly(glycolic acid) (PGA) may be produced by any suitable method, such as, for example, polycondensation of glycolic acid, or ring-opening polymerization of glycolide, or solid-state polycondensation of halogenoacetates; and PGAs are also readily commercially available. The PGA polymer in the degradable composites may comprise only an amorphous PGA, only a crystalline PGA, or a blend of amorphous and crystalline PGA. A PGA polymer blend can be a simple mechanical mixture of amorphous and crystalline PGA polymers.

In some embodiments, in addition to the boron containing degradation accelerant, multiple types of other degradation accelerants/fillers/additives may be included in the degradable composite materials of the present disclosure, where each degradation accelerant/filler/additive may contribute to the kinetics of the degradation of the polymer matrix (which comprises PGA). Such additional degradation accelerants/fillers/additives may include any suitable material, such as hygroscopic, hydrophilic, or water soluble solids, or gases. These materials may not only generate the interfacial surface area between the components of the degradable composition for faster water penetration but may also drive water into the degradable composites, such as in view of osmotic pressure differences that are generated and/or when the voids (that form as a result of the introduction of gases (such as inert gases, for example nitrogen gas) during the production process) are permeated with water.

Faster water penetration into the degradable composites may be desirable at lower temperatures where the rate of water penetration (for example, due to diffusion) is slow. Examples of suitable hygroscopic or water soluble solids that may be added to the degradable composite of the present disclosure may include sugar, salt (NaCl), ZnCl₂, CaCl₂, MgCl₂, NaCO₃, KCO₃, potassium phosphate (KH₂PO₄, K₂HPO₄, K₃PO₄), and sulfonate salts (such as sodium benzenesulfonate and sodium dodecylbenzenesulfonate), water soluble/hydrophilic polymers such as poly(ethylene-co-vinyl alcohol), EVOH, modified EVOH, SAP (super absorbent polymer), polyacrylamide or polyacrylic acid, and poly(vinyl alcohols) (PVOH), and the mixture of these materials.

An additional type of degradation accelerant/filler/additive that may be included in the degradable composite materials of the present disclosure includes phase-changing materials (e.g., materials that melt under downhole conditions) with predetermined melting points. Phase-changing materials, such as, for example, waxes may be used to increase free volume in the PGA polymers after the wax melts, increasing the porosity and thus water penetration into the polymers. Suitable waxes may include those that are hydrophobic crystalline solids. In such embodiments in which the degradable composite materials of the present disclosure comprise a phase changing material, when the degradable composite materials are exposed to a temperature above the melting point of the phase changing material (such as a wax) the phase changing material melts into a liquid form, and the volume of the wax decreases upon the phase transition that results in an increased free volume inside the PGA polymers for increased water penetration.

The phase changing material, such as a wax, may be selected, for example, based on the melting point of the phase changing material and the degradation temperature in the subterranean formation. For example, a paraffin wax may be selected chosen to blend with PGA for applications at low temperatures, such as temperatures below about 65° C., or temperatures below about 60° C., such as for applications in which the temperature is in the range of from about 30° C. to about 60° C., or in the range of from about 40° C. to about 55° C. Suitable waxes may include, for example, candelilla wax, carnauba wax, ceresin wax, Japan wax, microcrystalline wax, montan wax, ouricury wax, ozocerite, paraffin wax, rice bran wax, sugarcane wax, Paricin, Petrac wax, Petrac, PEtrac GMS Glycerol, monostearate silicon wax, Fischer-Tropsch wax, and Ross wax.

An additional type of degradation accelerant/filler/additive that may be included in the degradable composite materials (in addition to the boron containing accelerator, which may be in particulate form) includes reactive fillers, including bases or base precursors that generate hydroxide ions or other strong nucleophiles when in contact with water. Such reactive fillers can improve both the rate of water penetration into the composites and the rate of hydrolysis through the catalytic effect of nucleophiles.

Examples of suitable reactive fillers include, for example, Ca(OH)₂, Mg(OH)₂, CaCO₃, MgO, CaO, ZnO, NiO, CuO, Al₂O₃, and other bases or compounds that can convert to bases when in contact with water.

The particle sizes of the fillers can be in the range of 10 nm to several hundred nanometers, or even 1-5 microns in size, e.g., 50-300 nm. Smaller fillers with larger total surface area can result in faster degradation at the given temperatures compared to bigger fillers with smaller total surface area. The loading of the fillers as a weight percentage of the total composite can be in the range of 0.5% to 70%, depending on the choice of fillers and their molecular weight, and the desired characteristics of the final material.

In some embodiments, the degradation of the degradable composites of the present disclosure may be further accelerated when adding a small amount (such as less than about 1.5%, or less than about 1% by weight based on the total composite weight) of metal salts of long chain fatty acid C8) or esters of long chain fatty acids. Such amphiphilic additives may improve the boron-containing accelerant dispersion in the polymer matrix and promote water penetration into the composite. In some embodiments, the loading of the metal salts or esters of long chain fatty acids may be in the range of from about 0.1% to about 5%, or in the range of from about 0.3% to about 2%, weight percent of total composite.

In some embodiments, plasticizers may also be included in the degradable composites for smooth processing, and may even enhance the degradation of the composites. The plasticizers commonly used for plastics processing may be used. The choices of the plasticizers for developing the composites may depend on the choices of the degradable polymers, processing methods, processing temperatures, and the desired properties of the degradable composites. The plasticizers/accelerants/fillers/additives may be mechanically mixed with the degradable PGA polymers and the boron-containing accelerant during the compounding or extrusion processes.

Other small amounts of additives or polymers such as compatibilizers, fire retardants, anti-microbials, pigments, colorants, lubricants, UV stabilizers, thermal stabilizers, dispersants, nucleation agents, that are commonly used in the plastic processing industry may also be included. These additives include, for example, organic carboxylic acid, carboxylic acid ester, metal salts of organic carboxylic acid, multicarboxylic acid, fatty acid esters, fatty acid ethers, fatty acid amides, sulfonamides, polysiloxanes, organophosphorous compound, Al(OH)₃, quaternary ammonium compounds, silver base inorganic agents, carbon black, metal oxide pigments, dyes, silanes, and titanate.

In some embodiments, the degradable composite materials of the present disclosure may include a gaseous phase. Any suitable gas may be used, including, for example nitrogen, carbon dioxide, air, or methane). In examples of such embodiments, the gas may be present and/or trapped/encapsulated in the degradable composite materials in a range of from about 0.1% to about 40% by volume of the degradable composite materials, such as in a range of from about 5% to about 30% by volume of the degradable composite materials, or in a range of from about 10% to about 20% by volume of the degradable composite materials. The amount of gas to incorporate in the degradable composite materials may be affected by many factors including the bottom hole pressures involved in a particular application. In some embodiments, the amount of gas may be tailored to enhance buoyancy and give a lower density material for ease of transport and distribution. In some embodiments, the degradable composite materials of the present disclosure may include a plurality of particles that incorporate a that trap/encapsulate a different volume of gas to form a collection of particles with different densities (for example, the densities of the particles may be represented by a unimodal distribution of densities (which optionally may be, for example, uniform or Gaussian), or a bimodal distribution, or multimodal). In some embodiments, the degradable composite materials of the present disclosure may include a plurality of particles that incorporate a that trap/encapsulate a different volume of gas to form a collection of particles with different densities effective to give a uniform distribution of particulates in a fracture or any other oilfield applications. One of ordinary skill in the art, with the benefit of this disclosure, will recognize how much gas, if any, to incorporate into the degradable composite materials of the present disclosure.

In some embodiments, coatings or protective layers on the degradable composite materials surfaces or the boron-containing accelerant may be used to control or tune the degradation profiles, or protect the boron-containing accelerant during processing. The protective layers of polymers, monolayers, and coatings on the degradable composite materials and/or the boron-containing accelerant can be thin layers of hydrophobic monomer or polymers that protect (or block access to) the active surface of the boron-containing accelerant. This layer of protection may reduce the thermal degradation during common processing steps such as compounding, extrusion and melt spinning. The materials to form the protective layers may be any suitable material, such as, for example, materials selected from silanes, long chain alcohols, block copolymers of poly(ethylene glycol)-polypropylene oxide)-poly(ethylene glycol (PEG-PPO-PEG) or maleate modified EVA resins.

In some embodiments, the coating molecules may have functional groups that can interact with the boron-containing accelerant surface, as well as a hydrophobic component to blend well with one or more components of the PGA polymer matrix. The protective coating may be applied to the boron-containing accelerant surfaces through precoating or in situ adhesion. Selected silanes and long chain alcohols can be precoated to the boron-containing accelerant surfaces. Pluronic or maleate modified EVA resins, silanes and long chain alcohols may be co-compounded with the boron-containing accelerant and PGA resins, and achieve in situ adhesion between the functional group of the polymer and the boron-containing accelerant. In some embodiments, the coating may be between about 0.5% to about 5% by weight of the total filler weight, such as between about 1% to about 4% by weight of the total filler weight.

In some embodiments, when the degradable composite are immersed in water, the water will take time to swell and penetrate the coating and then interact with the boron-containing accelerant to generate nucleophiles that react with the PGA polymer matrix. In some embodiments, the degradation may be delayed for a predetermined amount of time by the presence of the coating, such as for a few hours to a few days and then complete within the time frame defined by the loading of the boron-containing accelerant. The delay of degradation time may be controlled through the choice of materials for coatings, as well as through the thickness of the coatings.

In some embodiments, the degradable PGA composites can be made using compounding, extrusion, solution polymerization of glycolic acid monomers with the boron-containing accelerant. In some embodiments, the level of moisture present in the PGA polymer, boron-containing accelerant, and in the compounding material is made to be low, such as below about 400 ppm water, or in a range of from about 300 ppm to about 10 ppm, or in a range of from about 100 ppm to about 20 ppm, prior to compounding using the extrusion process.

In some embodiments, the degradable PGA composites may be made using injection molding, compression molding, melt spinning or briquetting processes of the PGA comprising boron-containing accelerant.

In some embodiments, PGA polymer resins in the form of pellets can be grounded into powders under cryogenic conditions, and dried at an appropriate temperature for either amorphous or crystalline PGA. A portion of the PGA polymer powder may be premixed with the boron-containing accelerant, if desired, in an inert environment. The mixture of the PGA powders and the boron-containing accelerant can be extruded in an inert environment using any suitable compounder. The extrusion/compounding temperature may be set in any suitable range, depending on the choice of components in the composition and the PGA resins.

The maximum torque of each extrusion batch may be maintained at any suitable level, for example, such that the materials can be cycled inside the chamber for about 3 to about 4 minutes before flushing. The flushing can be stopped when the torque drops to a predetermined level. The diameter of the extruded degradable composite may be set at any desired diameter, such as a diameter in the range of from about 0.2 mm to about 10 mm, or a diameter in the range of from about 0.5 mm to about 5 mm.

In some embodiments, the degradable composite material may be a compounded particle of PGA, such as one that is compounded with air, such as to enhanced material properties that are highly desirable for sealing efficiency. In some embodiments, the degradable composite material components may be selected such that a particle of the degradable composite material will be more flexible then a PGA polymer particle and will produce an effective sealing agent with low leak off. For example, if desired, during extrusion processing, the PGA may be blended with suitable organic solids, suitable liquids, or inert gases. For example, in some embodiments, the extruded degradable composite material may be a material with gas entrapped therein, which may be used to decrease to Young's modulus, as desirable for the intended downhole operation. In this regard, PGA polymer has a Young's modulus of 6.5 GPa and thus when it is compounded with an inert gas, the degradable composite material can be made to become deformable/flexible (such that it is more rubber-like) with Young's modulus of about 0.05 GPa (such as in a range of from 0.01 GPa to 2.0 GPa, or in a range of from 0.03 GPa to 1.0 GPa). In some embodiments, the PGA may be compounded with reactive solids, liquids or gases, as desired, to manipulate the material physical properties of the degradable composite material, as well as the degradation rate of the PGA-based degradable composite material.

In some embodiments, the degradable PGA composite fibers or rods (made through extrusion) may be cut into any desirable length suitable for the intended downhole operation.

In some embodiments, the degradable composite composition may be in a form selected from the group consisting of a fiber, rod, sphere, a particle, a bead, a pellet, and an irregular shaped particle, where at least a portion (such as at least about 50% by weight, such as from about 50% by weight to about 100% by weight, or from about 60% by weight to about 99% by weight, relative to the total weight of the degradable composite composition) of the spheres, particles, beads, pellets, gravels, and/or irregular shaped particles, has a solubility such that the soluble portion of the fiber, rod, sphere, particle, bead, pellet, or irregular shaped particle dissolves within minutes (such as, for example, from about 5 to about 30 minutes), hours (such as, for example, from about 1 to about 12 hours), days (such as, for example, from about 1 to about 6 days) or weeks (such as, for example, from about 1 to about 4 weeks) depending upon the particular oilfield operation.

The degradable composite material comprising PGA and a boron-containing material (such as anhydrous borax) may be tailored such that the environment that degrades the composite material is one that is typically encountered downhole, such as, for example, an aqueous environment that includes formation water, seawater, salt (for example, brine), completion brine, stimulation treatment fluid, or remedial cleanup treatment fluid. In some embodiments, the degradable composite material may degrade by eroding, abrading, dissolving or disintegrating, or any combination thereof when desirable for a particular downhole application. In some embodiments, the degradation of the degradable composite material comprising PGA and a boron-containing material (such as anhydrous borax), may proceed within minutes, hours, days or weeks depending upon the particular oilfield operation.

The methods of the present disclosure that comprise fracturing or stimulation of a subterranean formation may include a degradable composite material comprising PGA and a boron-containing material (such as anhydrous borax), that may partially or completely dissolve, or break apart into multiple pieces (upon exposure to a predetermined downhole condition) in one or more aqueous fluids, but otherwise use conventional fracturing techniques known in the art.

A “wellbore” may be any type of well, including, a producing well, a non-producing well, an injection well, a fluid disposal well, an experimental well, an exploratory deep well, and the like. Wellbores may be vertical, horizontal, deviated some angle between vertical and horizontal, and combinations thereof, for example a vertical well with a non-vertical component.

The term “field” includes land-based (surface and sub-surface) and sub-seabed applications. The term “oilfield,” as used herein, includes hydrocarbon oil and gas reservoirs, and formations or portions of formations where hydrocarbon oil and gas are expected but may additionally contain other materials such as water, brine, or some other composition.

In embodiments, the degradable composite material comprising PGA and a boron-containing material (such as anhydrous borax), shape, size, thickness (diameter), density and/or concentration may be selected to be any suitable value that is effective to perform the intended downhole operation, such as downhole plugging to close a fracture and activate adjacent fracture in anticipation for augmented production, a gravel-packing type application to create temporary filter-cakes for sand control, drilling operations (including pumping the spheres, beads and gravels composed of the composition of the present disclosure containing a degradable composite material comprising PGA and a boron-containing material (such as anhydrous borax), within a treatment/carrier fluid of a predetermined viscosity to facilitate placement downhole, preventing and/or inhibiting particulate material flowback.

In embodiments, any desired additional particulate material may be used in the methods of the present disclosure, provided that it is compatible with the formation, the fluid, and the desired results of the treatment operation. For example, particulate materials may include sized sand, synthetic inorganic proppants, coated proppants, uncoated proppants, resin coated proppants, and resin coated sand.

Additional proppant may also be used, provided that it is compatible with the degradable composite material comprising PGA and a boron-containing material (such as anhydrous borax) of the present disclosure, the formation, the fluid, and the desired results of the treatment operation. Such proppants may be natural or synthetic (including silicon dioxide, sand, nut hulls, walnut shells, bauxites, sintered bauxites, glass, natural materials, plastic beads, particulate metals, drill cuttings, ceramic materials, and any combination thereof), coated, or contain chemicals; more than one may be used sequentially or in mixtures of different sizes or different materials. The proppant may be resin coated, provided that the resin and any other chemicals in the coating are compatible with the other chemicals of the present disclosure.

The proppant used in the methods of the present disclosure may have an average particle size of from about 0.15 mm to about 2.39 mm (about 8 to about 100 U.S. mesh), or of from about 0.25 to about 0.43 mm (40/60 mesh), or of from about 0.43 to about 0.84 mm (20/40 mesh), or of from about 0.84 to about 1.19 mm (16/20), or of from about 0.84 to about 1.68 mm (12/20 mesh) and or of from about 0.84 to about 2.39 mm (8/20 mesh) sized materials. The proppant may be present in a slurry (which may be added to the treatment fluid) in a concentration of from about 0.12 to about 3 kg/L, or about 0.12 to about 1.44 kg/L (about 1 PPA to about 25 PPA, or from about 1 to about 12 PPA; PPA is “pounds proppant added” per gallon of liquid).

In some embodiments, degradable composite material of the present disclosure may be coated with a material that will delay the contact between an environment capable of degrading the degradable composite material of the present disclosure, such as an aqueous environment. The terms “coated” or “coating”, as described herein may refer to encapsulation or simply to changing the surface by chemical reaction or by forming or adding a thin film of another material.

For example, degradable composite material may be coated with any known material that can be dissolved, degraded, or disintegrated (and/or eroded by physical abrasion, chemical etching, or a combination of physical abrasion and chemical etching) within a desirable period of time at a selected temperature in a selected fluid, such as hydrocarbons, treatment fluid, water, water-based drilling fluids, hydrocarbon-based drilling fluids, or a specific solution. Eroding includes partially or completely removing the coating. Partial removal of the coating during erosion, such as by wearing away patches, or strips, and/or scratches in the coating, which removes a portion of the surface of the coating and exposes the underlying degradable composite material, is in some embodiments sufficient to allow penetration of water to degrade the degradable composite material. Such physical abrasion may also be induced by interaction with some other treatment fluid component, such as a proppant. Abrasion may also be accomplished by other mechanical means, such as, for example, by insertion of a downhole tool or element and moving a tool or element with or against the coating to scratch or abrade the coating.

Suitable coating materials may include synthetic or natural materials that can dissolve in hydrocarbons, such as plastics, polymers, or elastomers. Examples of polymers may include polyolefin (such as polyethylene) polymers, paraffin waxes, polyalkylene oxides (such as polyethylene oxides), and polyalkylene glycols (such as polyethylene glycols). Suitable coating materials may also include biodegradable polymers, for example, polylactide (“PLA”).

The coating materials may dissolve, degrade, or disintegrate (and/or erode by physical abrasion, chemical etching, or a combination of physical abrasion and chemical etching) over any desired period of time, such as a period of time ranging from about 1 hour to about 480 hours, such as from about 1 to about 48 hours, or from about 1 to about 24 hours, and over a temperature range from about 50° C. to 250° C., such as from about 100° C. to about 250° C., or from about 150 to about 250° C. Additionally, a treatment fluid, water or some other chemicals may be used alone or in combination to dissolve the coating materials. Other fluids that may be used to dissolve the coating materials include alcohols, mutual solvents, and fuel oils such as diesel.

The methods of the present disclosure may include providing degradable composite material during a treatment operation of a subterranean formation. For example, a plug or porous solid pack may be formed that comprises the degradable composite material of the present disclosure.

In some embodiments, a fibrous material may also be included in the treatment fluid, which optionally may be made of the same composition as the degradable composite material. The fiber thickness (diameter), density and concentration may be any suitable value that is effective to assist in the oilfield operation. The fiber may be one or more member selected from natural fibers, synthetic organic fibers, glass fibers, ceramic fibers, carbon fibers, inorganic fibers, metal fibers, and a coated form of any of the above fibers.

In some embodiments, the degradable composite material may have an average density in the range of from about 0.8 g/cm³ to about 3.4 g/cm³, such as in the range of from about 1.0 g/cm³ to about 2.5 g/cm³, or in the range of from about 1.2 g/cm³ to about 2.0 g/cm³. In some embodiments, the degradable composite material may be prepared such that the density thereof matches that of an additional particulate material, such as proppants, employed; or the degradable composite material may be selected to have an average density that is within ±2% of the average density of the additional particulate materials, such as proppants, employed.

The treatment fluid capable of degrading and/or carrying the degradable composite material may be any well treatment fluid, such as a fluid loss control pill, a water control treatment fluid, a scale inhibition treatment fluid, a fracturing fluid, a gravel packing fluid, a drilling fluid, and a drill-in fluid. The carrier solvent for the treatment fluid may be a pure solvent or a mixture. Suitable solvents for use with the methods of the present disclosure, such as for forming the treatment fluids disclosed herein, may be aqueous or organic based. Aqueous solvents may include at least one of fresh water, sea water, brine, mixtures of water and water-soluble organic compounds and mixtures thereof. Organic solvents may include any organic solvent that is able to dissolve or suspend the various components, such as the chemical entities and/or components of the treatment fluid.

Suitable organic solvents may include, for example, alcohols, glycols, esters, ketones, nitrites, amides, amines, cyclic ethers, glycol ethers, acetone, acetonitrile, 1-butanol, 2-butanol, 2-butanone, t-butyl alcohol, cyclohexane, diethyl ether, diethylene glycol, diethylene glycol dimethyl ether, 1,2-dimethoxy-ethane (DME), dimethylether, dibutylether, dimethyl sulfoxide (DMSO), dioxane, ethanol, ethyl acetate, ethylene glycol, glycerin, heptanes, hexamethylphosphorous triamide (HMPT), hexane, methanol, methyl t-butyl ether (MTBE), N-methyl-2-pyrrolidinone (NMP), nitromethane, pentane, petroleum ether (ligroine), 1-propanol, 2-propanol, pyridine, tetrahydrofuran (THF), toluene, triethyl amine, o-xylene, m-xylene, p-xylene, ethylene glycol monobutyl ether, polyglycol ethers, pyrrolidones, N-(alkyl or cycloalkyl)-2-pyrrolidones, N-alkyl piperidones, N, N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, alkylene carbonates, alkyl carbonates, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, dibutyl carbonate, lactones, nitromethane, nitrobenzene sulfones, tetrahydrofuran, dioxane, dioxolane, methyltetrahydrofuran, dimethylsulfone, tetramethylene sulfone, diesel oil, kerosene, paraffinic oil, crude oil, liquefied petroleum gas (LPG), mineral oil, biodiesel, vegetable oil, animal oil, aromatic petroleum cuts, terpenes, mixtures thereof.

While the treatment fluids of the present disclosure are described herein as comprising the above-mentioned components, it should be understood that the treatment fluids of the present disclosure may optionally comprise other chemically different materials. In embodiments, the treatment fluid may further comprise stabilizing agents, surfactants, diverting agents, or other additives. Additionally, a treatment fluid may comprise a mixture of various crosslinking agents, and/or other additives, such as fibers or fillers, provided that the other components chosen for the mixture are compatible with the intended use of the treatment fluid. Furthermore, the treatment fluid may comprise buffers, pH control agents, and various other additives added to promote the stability or the functionality of the treatment fluid. The components of the treatment fluid may be selected such that they may or may not react with the subterranean formation that is to be treated.

In this regard, the treatment fluid may include components independently selected from any solids, liquids, gases, and combinations thereof, such as slurries, gas-saturated or non-gas-saturated liquids, mixtures of two or more miscible or immiscible liquids, and the like, as long as such additional components allow for the desired degradation of the degradable composite material of the present disclosure. For example, the treatment fluid may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like.

In embodiments, the treatment fluid may be driven into a wellbore by a pumping system that pumps one or more treatment fluids into the wellbore. The pumping systems may include mixing or combining devices, wherein various components, such as fluids, solids, and/or gases maybe mixed or combined prior to being pumped into the wellbore. The mixing or combining device may be controlled in a number of ways, including, but not limited to, using data obtained either downhole from the wellbore, surface data, or some combination thereof.

The foregoing is further illustrated by reference to the following examples, which are presented for purposes of illustration and are not intended to limit the scope of the present disclosure.

### Examples

A composite of PGA pellets from Kureha (grade 110R00) and anhydrous borax from Alfa Aesar (CAS 1330-43-4, Catalog number 12305) was prepared using a single screw extruder at 465° F. The anhydrous Borax was reduced in size from 1680 μm to circa d_{—50} 40 μm before preparing a 7 weight percent degradable composite material. The degradation of the composite extruded pellets at 150° F., 130° F. and 100° F. was monitored by forming a 1 weight percent solution in deionized water and regularly monitoring its weight. The percentage degradation was calculated by monitoring the weight change with time.

The percentage degradation of the PGA polymer and PGA compounded with Borax was measured using the following procedure: 0.2 grams (about 1 weight percent) of the tested material was placed in a glass vial containing 20 mL of deionized water and the vial was subsequently sealed. The sealed vial was then placed in an oven at the test temperature. After the predetermined amount of time, the vial was removed from the oven and allowed to cool down to ambient temperature. The pH of the test fluid was measured and the test material was filtered out using 2.7 micron filter paper. Thereafter the filtered sample was dried for at least 12 hours in an oven at 200° F. and then the dried sample was weighted. The following equation was used to calculate the percent degradation using mass balance:

$$\frac{Initial weight - Dry weight}{Initial weight} \times 100 = \% Degradation$$

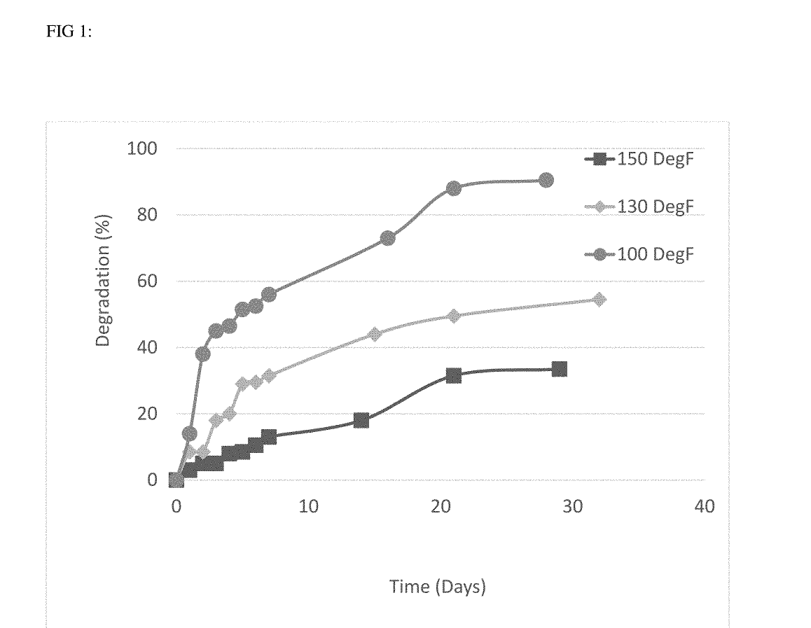

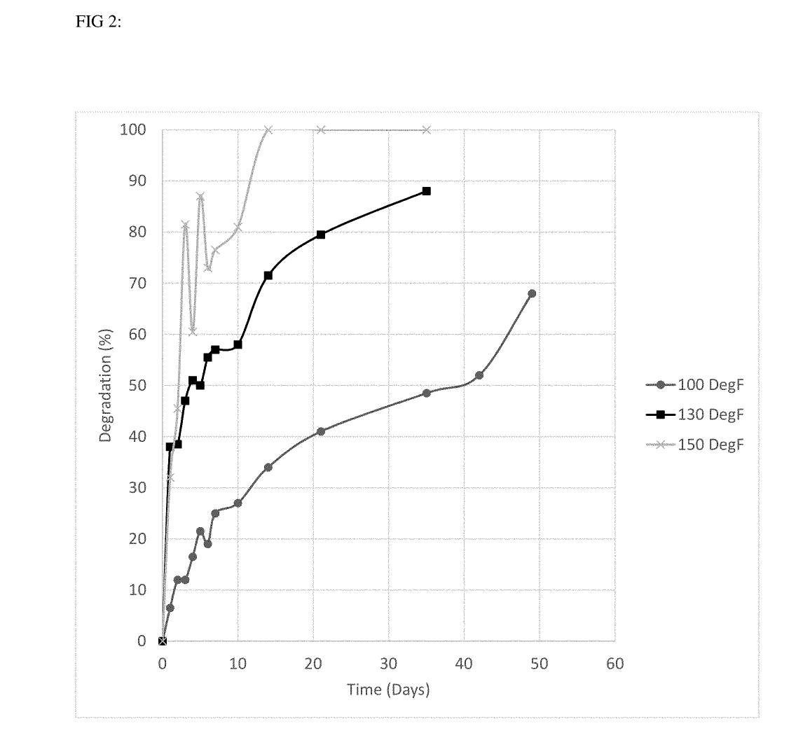

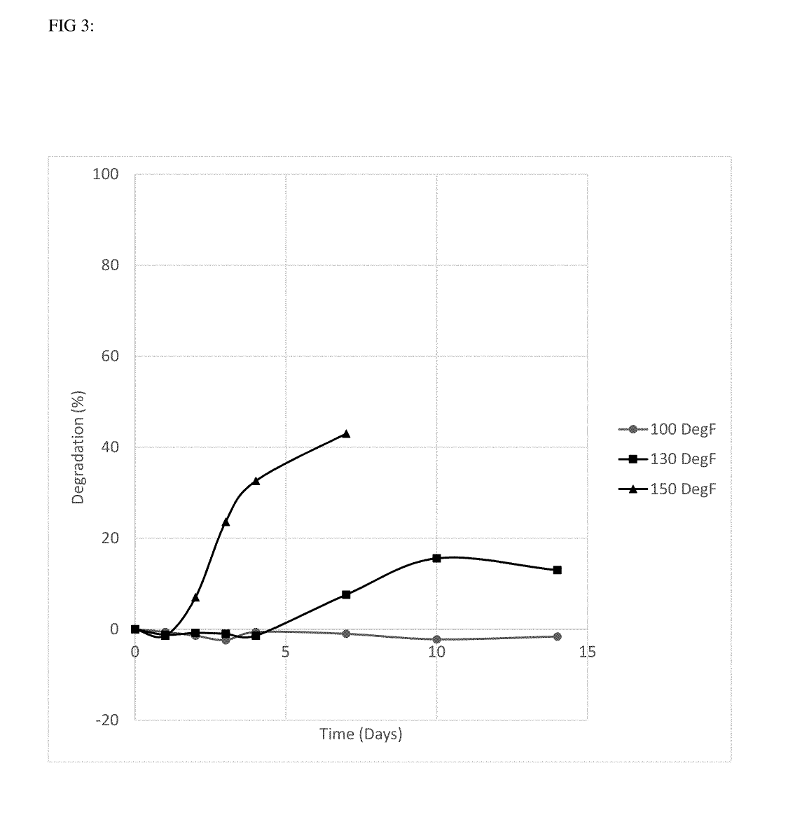

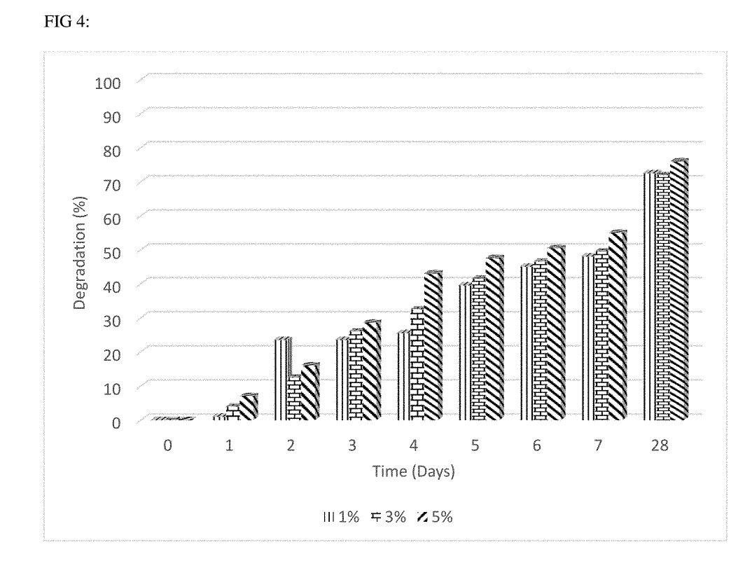

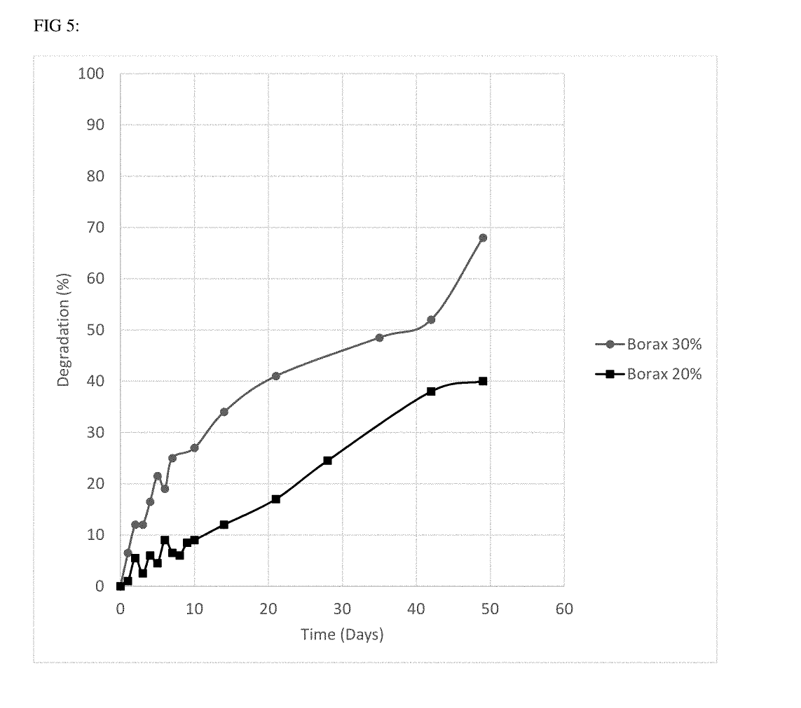

The results are shown in FIG. 1, which depicts the degradation profile at 150° F., 130° F. and 100° F. of the composite including PGA compounded with 7% anhydrous borax. Further tests (the results of which are shown in FIG. 2) were conducted with a 30% anhydrous borax composite prepared in a similar manner to that described above. As illustrated by comparing the data in FIGS. 1 and 2 with that of FIG. 3 (where the borax accelerator was omitted), the degradation kinetics are dependent not only on temperature, but also the presence of the anhydrous borax accelerator. As confirmed by the data set forth in FIGS. 4 and 5, which illustrates the effect of increasing the concentration of the borax accelerator (FIG. 4: borax accelerator concentrations of 1, 3 and 5 weight percent at 150° F.; and FIG. 5: borax accelerator concentrations of 20 and 30 weight percent at a temperature of 100° F.).

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of COMPOSITIONS AND METHODS FOR TREATING A SUBTERRANEAN FORMATION. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method for treating a subterranean formation, comprising:
injecting, into a downhole environment, a fluid comprising:
a degradable composite material comprising polyglycolic acid, a boron-containing accelerator, and a metal salt or an ester of a fatty acid;
forming a plug comprising the degradable composite material at a first location in the subterranean formation;
diverting the fluid to a second location in the subterranean formation; and
removing the plug formed in the first location in the subterranean formation.

2. The method of claim 1, wherein the degradable composite material further comprises a salt, inorganic acid, an organic acid, acid precursor or combination thereof in an amount up to about 10% by weight relative to the total weight of the degradable composite material.

3. (canceled)

4. The method of claim 1, wherein the boron-containing accelerator is encapsulated.

5. The method of claim 1, wherein the boron-containing accelerator is anhydrous.

6. The method of claim 1, wherein the boron-containing accelerator is uniformly distributed in the polyglycolic acid of the degradable composite material.

7. The method of claim 1, wherein the boron-containing accelerator is present as a layer on a surface of the polyglycolic acid of the degradable composite material.

8. The method of claim 1, wherein the boron-containing accelerator comprises a plurality of boron-containing accelerator particles including at least a first particle size and a second particle size.

9. The method of claim 8, wherein the first particle size and the second particle size are different, and the plurality of boron-containing accelerator particles comprises a bimodal distribution of particle sizes.

10. The method of claim 1, wherein the boron-containing accelerator comprises a plurality of boron-containing accelerator particles including at least a first particle shape and a second particle shape.

11. The method of claim 10, wherein the first particle shape and the second particle shape are different.

12. The method of claim 1, wherein the degradable composite material is a plurality of degradable composite particles including at least a first composite particle size and a second composite particle size.

13. The method of claim 12, wherein the first composite particle size and the second composite particle size are different.

14. The method of claim 1, wherein the degradable composite material comprises a plurality of degradable composite shapes including at least a first composite particle type and a second composite particle type.

15. The method of claim 14, wherein the first composite particle type and the second composite particle type are different.

16. The method of claim 15, wherein
the first composite particle type is a fiber,
the second composite particle type is a particle, and
the degradable composite material of the fiber and the particle is identical.

17. The method of claim 1, wherein the degradable composite material is a fiber.

18. The method of claim 1, wherein removing the plug formed in the first location in the subterranean formation comprises chemically degrading the degradable composite material.

19. The method of claim 1, wherein removing the plug formed in the first location in the subterranean formation comprises physically degrading the degradable composite material.

20. The method of claim 1, wherein the fluid further comprises non-degradable particulates.

21. (canceled)
